(19) United States
(12) Patent Application Publication
(10) Pub. No.: US 2013/0081299 A1
(43) Pub. Date: Apr. 4, 2013

(54) DRYER SHEET HOLDER

(71) Applicant: EZ Grab LLC, West Valley City, UT (US)

(72) Inventor: Emelia Vasquez, West Valley City, UT (US)

(73) Assignee: EZ GRAB LLC, West Valley City, UT (US)

(21) Appl. No.: 13/633,768

(22) Filed: Oct. 2, 2012

Related U.S. Application Data
(60) Provisional application No. 61/542,984, filed on Oct. 4, 2011.

(51) Int. Cl. B65D 85/00; F26B 7/00; F26B 19/00

(52) U.S. Cl. 34/389; 206/555; 34/202

(57) ABSTRACT

Implementations of the present invention relate to systems, methods, and apparatus for storing dryer sheets at a location convenient to the user. Particularly, at least one implementation includes a dryer sheet holder that can couple to a desired support surface. Such dryer sheet holder also can allow the user to access dryer sheets at the more convenient location and can, thereby, reduce time of the drying process. Moreover, the dryer sheet holder may improve the dying process by reducing the number of unintentional omissions of dryer sheet from drying laundry loads.

### CROSS-REFERENCE TO RELATED APPLICATIONS

This application claims the benefit of priority to U.S. Provisional Application No. 61/542,984, filed Oct. 4, 2011, entitled “Dryer Sheet Holder,” the entire content of which is incorporated herein by reference.

### BACKGROUND OF THE INVENTION

1. The Field of the Invention

This invention relates to systems, methods, and apparatus for storing dryer sheets as well as for consistently incorporating dryer sheets into drying loads of laundry.

2. Background and Relevant Art

Clothes washing and drying is a task frequently performed many people. Typical settings for such activities include commercial washing and/or dry cleaning outfits, laundromats (e.g., coin-operated laundromats), and individuals' homes. When a user places a load of washed laundry into a dryer, the user also may include a dryer sheet. Dryer sheet are usually used to soften the drying laundry as well as to reduce static charges on individual pieces of laundry, which may accumulate thereon due to friction and rubbing therebetween during a drying cycle.

Typical dryer sheets are sold in a box or a large bundle, which includes a stack of dryer sheets. The user can remove individual sheets from the bundle and place such sheets into the dryer, together with a load of washed laundry. Additionally, users may keep the dryer sheet bundles in a cabinet or similar storage, for example, to have unrestricted access to and use of a top surface of the washing and/or drying machines. Thus, the user may have to retrieve the dryer sheets from the cabinet, before placing the dryer sheets into the dryer.

In some instances, retrieval of the dryer sheets from the cabinet may present a substantial inconvenience to the user. For instance, retrieving dryer sheets can add time to the overall drying process. Moreover, with the dryer sheets out of sight, the user may, from time to time, forget to add dryer sheets to the drying laundry load.

Accordingly, there are a number of disadvantages in conventional storage of dryer sheets that can be addressed.

### BRIEF SUMMARY OF THE INVENTION

Implementations of the present invention provide systems, methods, and apparatus for securing and storing dryer sheets in a manner that is convenient to the user. Particularly, at least one implementation includes a dryer sheet holder that can couple to a desired support surface. For example, the user can select an appropriate or desired support surface and can secure the dryer sheet holder thereto. Hence, such dryer sheet holder can allow the user to access dryer sheets at a more convenient location and can, thereby, reduce the time of a drying process. Storing dryer sheets in a more convenient manner (e.g., at a more convenient location) also may improve repeatability of the drying process, by allowing the user to include dryer sheets with the drying laundry loads more consistently.

One or more implementations include a flexible dryer sheet holder for holding dryer sheets at a convenient location relative to a drying machine. Such the flexible dryer sheet holder includes a front panel having a left edge, a right edge, a top edge, and a bottom edge. The front panel has a dispensing opening therethrough. The flexible dryer sheet holder also includes a back panel having a left edge, a right edge, a top edge, and a bottom edge. The left edge of the front panel is coupled to the left edge of the back panel. The right edge of the front panel is coupled to the right edge of the back panel. The bottom edge of the front panel is coupled to the bottom edge of the back panel. Moreover, when coupled, the bottom edges of the front and back panels are configured to form a holding compartment for storing a plurality of dryer sheets. Also, the dispensing opening in the front panel is configured to allow access to a front dryer sheet of the plurality of dryer sheets. The flexible dryer sheet holder also includes one or more coupling fasteners secured to the back panel, the one or more fasteners being configured to couple the back panel to a support surface.

One or more other implementations include a clothes drying system for drying a load of laundry and consistently incorporating one or more dryer sheets into the load of laundry during the drying thereof in a drying machine. Such system includes a flexible dryer sheet holder coupled to a support surface on or near the drying machine. The flexible dryer sheet holder at least partially conforms to the contour of the support surface. Furthermore, the flexible dryer sheet holder has a front panel at least partially removably coupled to a back panel, such that the front and back panels form a dryer sheet holding compartment. Additionally, the flexible dryer sheet holder has one or more dryer sheets located in the dryer sheet compartment, and a dispensing opening in the front panel. The dispensing opening in the front panel is configured to allow access to at least one dryer sheet of the one or more dryer sheets located in the dryer sheet holding compartment.

Implementations of the present inventions also include a method of providing dryer sheets to a user who is placing a load of laundry into a drying machine, before commencement of a drying process, in a manner that facilitates more frequent use of the dryer sheets during the drying process and aids unintentional omissions of the dryer sheets from the drying process by the user. The method includes coupling a flexible dryer sheet holder to a support surface on or near a drying machine in a manner that a back panel of the dryer sheet holder at least partially conforms to the support surface. The method also includes opening a dryer sheet holding compartment of the dryer sheet holder by at least partially decoupling a front panel from the back panel of the dryer sheet holder. Further, the method includes inserting a plurality of dryer sheets into the dryer sheet compartment of the dryer sheet holder, and closing the dryer sheet holding compartment by at least partially coupling the front panel to the back panel of the dryer sheet holder. Additionally, the method includes an act of allowing the user to access the dryer sheets located in the dryer sheet holding compartment by having at least a portion of a front dryer sheet of the plurality of dryer sheets accessible through a dispensing opening in the front panel of the dryer sheet holder.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a front perspective view of a dryer sheet holder secured to a support surface in accordance with one implementation of the present invention;

FIG. 2A illustrates a front perspective view of a partially opened dryer sheet holder in accordance with one implementation of the present invention;

FIG. 2B illustrates a front perspective view of a fully opened dryer sheet holder of FIG. 2A;

FIG. 3 illustrates a front perspective view of a fully opened dryer sheet holder in accordance with another implementation of the present invention;

FIG. 4 illustrates a front perspective view of a partially opened dryer sheet holder in accordance with one implementation of the present invention;

FIG. 5 illustrates a back perspective view of a partially opened dryer sheet holder in accordance with another implementation of the present invention;

FIG. 6 illustrates a back perspective view of a partially opened dryer sheet holder in accordance with yet one other implementation of the present invention; and

FIG. 7 illustrates a perspective view of a clothes drying system in accordance with one implementation of the present invention.

### DETAILED DESCRIPTION OF THE PREFERRED EMBODIMENTS

Implementations of the present invention provide systems, methods, and apparatus for securing and storing dryer sheets in a manner that is convenient to the user. Particularly, at least one implementation includes a dryer sheet holder that can couple to a desired support surface. For example, the user can select an appropriate or desired support surface and can secure the dryer sheet holder thereto. Hence, such dryer sheet holder can allow the user to access dryer sheets at a more convenient location and can, thereby, reduce the time of a drying process. Storing dryer sheets in a more convenient manner (e.g., at a more convenient location) also may improve repeatability of the drying process, by allowing the user to include dryer sheets with the drying laundry loads more consistently.

In one or more implementations, the dryer sheet holder can conform to the support surface that secures the dryer sheet holder. For instance, at least a portion of the dryer sheet holder can comprise flexible and/or deformable material, such as to allow the dryer sheet holder to conform to the particular two- or three-dimensional profile of the support surface. Consequently, a profile of the dryer sheet holder can remain relatively unobtrusive with respect to the support surface and/or overall user's environment.

Moreover, the dryer sheet holder can removably attach to the support surface. Particularly, the user can secure the dryer sheet holder to the support surface and can remove the dryer sheet holder therefrom without damage. Hence, the user can temporarily secure the dryer sheet holder to various surfaces, including but not limited to surfaces on the washing and/or drying machines. Accordingly, the user can remove and/or relocate the dryer sheet holder based on the user's needs.

Generally, the dryer sheet holder can hold and dispense multiple dryer sheets. Thus, the dryer sheet holder can include a holding compartment and an opening for dispensing dryer sheets, such as a dispensing opening. The user can access the holding compartment to replenish the supply of dryer sheets therein. In other words, the user can add and/or remove dryer sheets into/from the holding compartment, and can remove the dryer sheets through the dispensing opening on need-basis.

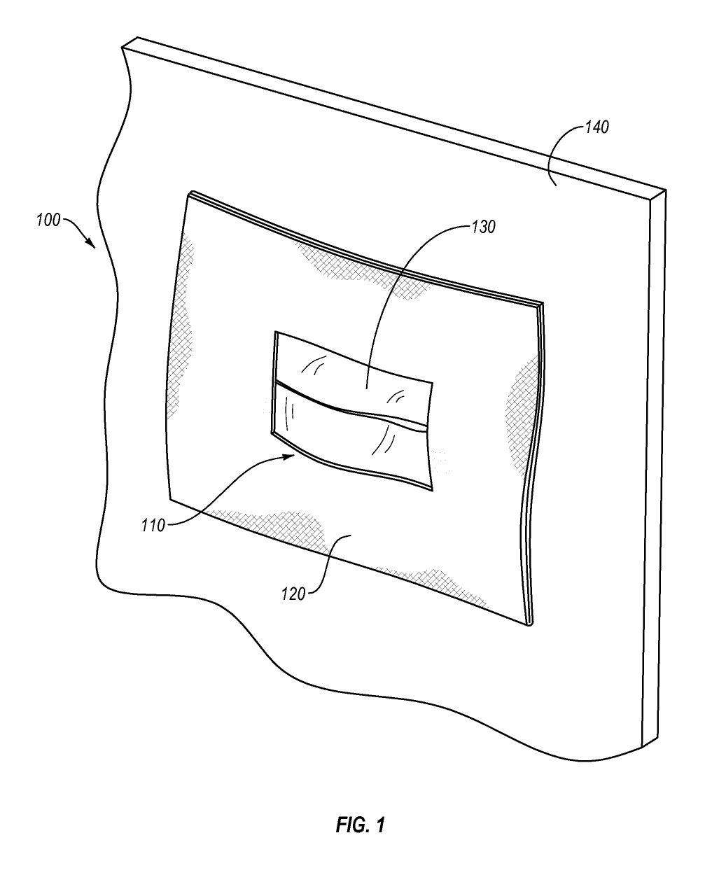

For example, as illustrated in FIG. 1, a dryer sheet holder 100 can include a dispensing opening 110. In at least one implementation, the dryer sheet holder 100 can have a front panel 120 (or front portion) that has the dispensing opening 110. Accordingly, as described above, the user can remove dryer sheets 130 from the dispensing opening 110 in the front panel 120. Furthermore, for convenient access to the dryer sheets 130, the user can secure the dryer sheet holder 100 to any suitable support surface 140 at a desired location.

The support surface 140 can be a vertical support surface 140, as shown in the illustrated implementation. For instance, as further described below, the vertical support surface 140 can be a wall, a sidewall of a cabinet, a sidewall of a washing or drying machine, etc. In light of this disclosure, those skilled in the art should appreciate that a vertical support surface 140 oftentimes may be otherwise unused. Thus, securing the dryer sheet holder 100 to such vertical support surface 140 can allow the user to optimize the use of the space, for example, in the proximity of the drying machine.

In some instances, the user may desire to utilize available horizontal surfaces for other tasks. For example, the user can temporarily store washed and/or dried laundry on an available horizontal surface, such as on the top of the washing or drying machine. Consequently, securing the dryer sheet holder 100 to the vertical support surface 140 may be advantageous to the user.

Nevertheless, it should be noted that this invention is not so limited. More specifically, the user can secure the dryer sheet holder 100 to any available, suitable, and/or conveniently located support surface 140. Hence, the user may choose to secure the dryer sheet holder 100 to a horizontal support surface 140 or to a support surface 140 that has any other orientation. For instance, the user may secure the dryer sheet holder 100 to a horizontal support surface 140 that forms an underside of a cabinet. Thus, the user may remove the dryer sheets 130 from the dryer sheet holder 100 with a downward motion.

In any event, the user may choose an optimal location for the dryer sheet holder 100. Furthermore, as noted above, the user can removably secure the dryer sheet holder 100 to the support surface 140. Accordingly, the user can secure the dryer sheet holder 100 to a first support surface 140 and subsequently move the dryer sheet holder 100 to a second support surface 140. In other words, the user can determine a particular optimal location for the dryer sheet holder 100 by securing the dryer sheet holder 100 to a first support surface 140 and using the dryer sheet holder 100 for a period of time. Thereafter, the user may choose to relocate the dryer sheet holder 100 to a second support surface 140, to determine whether the dryer sheet holder 100 secured to the second support surface 140 provides a more convenient location for the user.

Depending on the type of the support surface 140 that the user wants to utilize, as further described below, the dryer sheet holder 100 can incorporate various types of fasteners to secure the dryer sheet holder 100 to the particular support surface 140. For instance, the dryer sheet holder 100 can incorporate magnetic fasteners to secure the dryer sheet holder 100 to a ferromagnetic support surface 140, such as steel (e.g., to a side of a drying machine). In at least one implementation, the dryer sheet holder 100 can incorporate adhesive fasteners, which can removably secure the dryer sheet holder 100 to essentially any suitable support surface 140.

In addition, one will appreciate that magnetic fasteners are only one type of fastener element which the dryer sheet holders of the present invention may include. For example, dryer sheet holders according to one or more implementations of the present invention can also or alternatively use other forms of fastening elements that include, but are not limited to, hook and loop elements, snap elements, and/or types of friction-based fasteners. Depending on the design and function of the given fastener elements, the dryer sheet holders can include any number or arrangement of such fastener elements as needed to ensure an appropriate connection. Furthermore, the discussion regarding the coupling fasteners that attach the dryer sheet holder to a support surface, equally applies to the other fasteners described herein below.

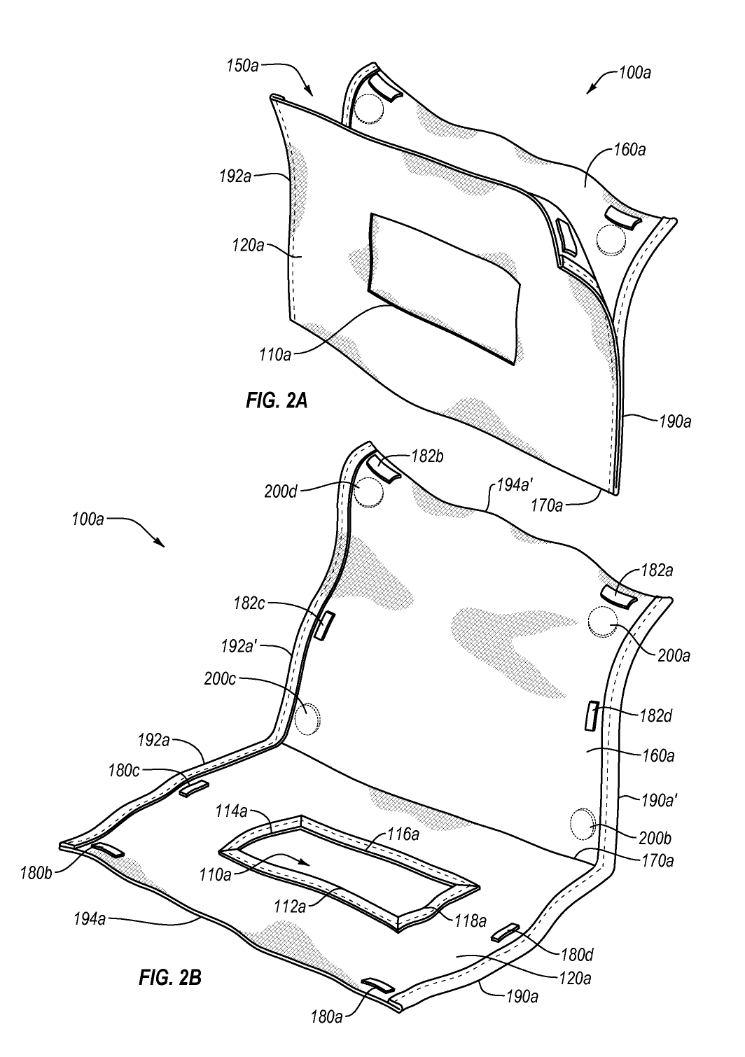

As described above, the dryer sheet holder can incorporate a holding compartment, which can store dryer sheets. For instance, as illustrated in FIG. 2A, a dryer sheet holder 100a can have a holding compartment 150a. Except as otherwise described below, the dryer sheet holder 100a can be substantially the same as the dryer sheet holder 100 (FIG. 1). The holding compartment 150a may reside between a front panel 120a and the back portion of the dryer sheet holder 100a, such as a back panel 160a. In at least one implementation, the front panel 120a and the back panel 160a can have substantially the same shapes and sizes. For example, the front panel 120a and the back panel 160a can be approximately rectangular. Also as noted above, the front panel 120a can include a dispensing opening 110a.

In at least one implementation, to form the holding compartment 150a, the front panel 120a can couple to the back panel 160a. For instance, the front panel 120a and the back panel 160a can couple to each other around the respective perimeters thereof. Particularly, the front panel 120a and back panel 160a can comprise a single sheet of material, folded about and forming a bottom edge 170a. Additionally, as further illustrated in FIG. 2B, the front panel 120a and/or the back panel 160a can have fasteners, such as front fasteners 180a, 180b, 180c, 180d and/or back fasteners 182a, 182b, 182c, 182d, which can couple the front panel 120a and the back panel 160a together.

The respective front and back fasteners 180a, 180b, 180c, 180d, 182a, 182b, 182c, 182d can vary from one implementation to another. In one or more implementations, the front and back fasteners 180a, 180b, 180c, 180d, 182a, 182b, 182c, 182d can be hook and loop fasteners that can respectively couple to one another. Additionally or alternatively, the front and back fasteners 180a, 180b, 180c, 180d, 182a, 182b, 182c, 182d can be magnetic type fasteners, with one side comprising a magnet and an opposing side comprising either a ferromagnetic material or a magnet of an opposite polarity. As noted above, in one or more implementations only one of the front panel 120a and back panel 160a can have fasteners. For instance, the front or back fasteners 180a, 180b, 180c, 180d, 182a, 182b, 182c, 182d can be hook fasteners and opposing panel (i.e., either the front panel 120a or the back panel 160a) can comprise material having loops configured to accept and secure the hook fasteners.

In at least one implementation, the front and/or back fasteners 180a, 180b, 180c, 180d, 182a, 182b, 182c, 182d may be invisible or hidden within the material of the front panel 120a and/or back panel 160a, respectively. Particularly, the front panel 120a and/or back panel 160a can integrate or secure the front and back fasteners 180a, 180b, 180c, 180d, 182a, 182b, 182c, 182d inside the material thereof. For example, as further described below, the front panel 120a and/or back panel 160a can comprise a fabric sheet material. Thus, a manufacturer can secure the front and/or back fasteners 180a, 180b, 180c, 180d, 182a, 182b, 182c, 182d between a folded fabric sheet that forms the front panel 120a and/or back panel 160a.

In any event, in one or more implementations, the front and back fasteners 180a, 180b, 180c, 180d, 182a, 182b, 182c, 182d can removably couple the front panel 120a to the back panel 160a around the edges thereof. Particularly, a right edge 190a of the front panel 120a can couple to a right edge 190a′ of the back panel 160. Similarly, a left edge 192a can couple to a left edge 192a′ and/or a top edge 194a can couple to a top edge 194a′.

Accordingly, the user can decouple the respective left, right, and/or top edges 190a, 190a′, 192a, 192a′, 194a, 194a′ (as may be applicable in a particular implementation of the invention) to access the holding compartment 150a. Thereafter, the user may insert dryer sheets between the front panel 120a and the back panel 160a and re-couple or reconnect the respective left, right, and/or top edges 190a, 190a′, 192a, 192a′, 194a, 194a′, by reattaching the respective fasteners. After the front panel 120a and the back panel 160a are reconnected, the user can remove dryer sheets through the dispensing opening 110a.

Furthermore, the user can arrange the dryer sheets inside the holding compartment 150a in a manner that can allow the user to pull a subsequent dryer sheet partially through the dispensing opening 110a after removing a preceding dryer sheet therefrom. For example, the dryer sheets can overlap one another, such that one dryer sheet is partially enclosed in a subsequent dryer sheet. Consequently, as the user pulls the preceding dryer through the dispensing opening 110a, the connection formed between the preceding dryer sheet and the subsequent dryer sheet by enclosing a portion of the former in the latter, can pull the subsequent dryer sheet at least partially through the dispensing opening 110a. Thus, the user can have immediate and easy access to the subsequent dryer sheet, without inserting a hand through the dispensing opening 110a.

The dryer sheet holder 100a can couple to a support surface. For instance, the dryer sheet holder 100a can include coupling fasteners 200a, 200b, 200c, 200d, which can secure the dryer sheet holder 100a to the support surface. As described above, the manufacturer can use various fasteners, which may vary from one implementation to another, and which may depend on the characteristics and type of the particular support surface. Additionally, the coupling fasteners 200a, 200b, 200c, 200d may be hidden or concealed from the user's view, such that the user cannot see the coupling fasteners 200a, 200b, 200c, 200d when the dryer sheet holder 100a is in an open configuration (illustrated in FIG. 2B).

Moreover, the dryer sheet holder 100a can be sufficiently flexible to conform to the support surface that may secure the dryer sheet holder 100a. In other words, to the extent that the support surface is not flat, the back panel 160a and/or the front panel 120a may conform to the curvature of the support surface. For example, the back panel 160a and/or the front panel 120a may comprise a flexible material, such as a fabric, thermoplastic sheets, thin metal sheets, etc. Thus, such material of the back panel 160a and/or of the front panel 120a can conform to the support surface. As mentioned above, when conformed to the two- or three-dimensional curvature of the support surface, the dryer sheet holder 100a can occupy less space (than a comparable non-conformable dryer sheet holder) and also may have a pleasing aesthetic to the user.

In addition to providing flexibility to the dryer sheet holder 100a, the front panel 120a and/or back panel 160a that comprise fabric material can increase longevity of the dryer sheet holder 100a. For example, after a period of use, the user can remove the dyer sheets from the dryer sheet holder 100a and decouple the dryer sheet holder 100a from the support surface. Subsequently, the user can wash and dry the dryer sheet holder 100a, reinsert the dryer sheets into the holding compartment 150a (FIG. 2A), and re-couple the dryer sheet holder 100a to the support surface. Accordingly, in the event the dryer sheet holder 100a becomes soiled or stained, the user can simply wash the dryer sheet holder 100a and re-deploy the dryer sheet holder 100a back into service.

Also, in one or more implementations, the fabric can have a relatively low coefficient of friction (e.g., nylon, polyester, etc.). Particularly, a surface of the fabric can be substantially smooth. As such, the fabric can facilitate easy removal of the dryer sheets from the dryer sheet holder 100a. Moreover, low coefficient of friction can reduce removal of any coating material from the dryer sheets onto the dryer sheet holder 100a. Accordingly, the dryer sheet holder 100a can remain cleaner and less contaminated (e.g., with coating material from the dryer sheets, hand oils, etc.) over longer periods of use, as compared with a similar dryer sheet holder that comprises material with higher coefficient of friction (e.g., cardboard).

In at least one implementation, as shown by FIG. 2B, the manufacturer can fold one or more of the left, right, and/or top edges 190a, 190a′, 192a, 192a′, 194a, 194a′. A folded edge can provide a more pleasing aesthetic to the user. Furthermore, folding the material to form the edges also can protect the material proximal to the edges and/or can protect the user of the dryer sheet holder 100a. For example, when the front panel 120a and/or the back panel 160a comprise a fabric sheet, folding the material to form the edges 190a, 190a′, 192a, 192a′, 194a, 194a′ can protect threads of material proximal such edges from unweaving from the fabric sheet. Also, when the front panel 120a and/or back panel 160a comprise a thermoplastic or metallic sheet material, the manufacturer can fold such material to form rounded edges 190a, 190a′, 192a, 192a′, 194a, 194a′, thereby protecting the user of the dryer sheet holder 100a from potential cuts on the material edges.

Similarly, as shown by FIG. 2B, the manufacturer can form edges 112a, 114a, 116a, 118a of the dispensing opening 110a by folding the material of the front panel 120a. Such folded edges 112a, 114a, 116a, 118a can be more aesthetically appealing to the user. Moreover, the folded edges 112a, 114a, 116a, 118a can further reduce friction between the front panel 120a and the dryer sheets, as the dryer sheets are removed from the dispensing opening 110a.

In light of this disclosure, it should be apparent to those skilled in the art that the fold of the material may be secured in any number of ways, which may vary depending on the type of material used as well as from one implementation of the invention to the other. For instance, the manufacturer can stitch the fabric sheet material along the fold (as indicated by the dashed lines in FIGS. 2A, 2B). Additionally or alternatively, the manufacturer can use a suitable adhesive to secure the fold. Moreover, in at least one implementation, where the manufacturer utilizes thermoplastic or metallic material for the front panel 120a and/or back panel 160a, the manufacturer also can weld the material to secure the fold.

Moreover, as noted above, in one or more implementations, the fasteners 180a, 180b, 180c, 182a, 182b, 182c can be concealed from the user. For instance, the manufacturer can at least partially conceal the fasteners 180a, 180b, 180c, 182a, 182b, 182c within the folds that from the edges 190a, 190a′, 192b, 192a′, 192a, 194a′. Suitable fasteners 180a, 180b, 180c, 182a, 182b, 182c include magnetic fasteners, buttons, snaps, etc.

As illustrated in FIG. 2B, in one or more implementations, the dispensing opening 110a can have a substantially rectangular shape. The dispensing opening 110a also can have a size sufficient to allow the user to remove the dryer sheets without damage. Hence, the size of the dispensing opening 110a can change from one implementation to the other and may depend on the size and shape of the particular dryer sheets utilized. Furthermore, in light of this disclosure and as further elaborated below, it should be apparent to those skilled in the art that the shape of the dispensing opening 110a also can change from one implementation to the other.

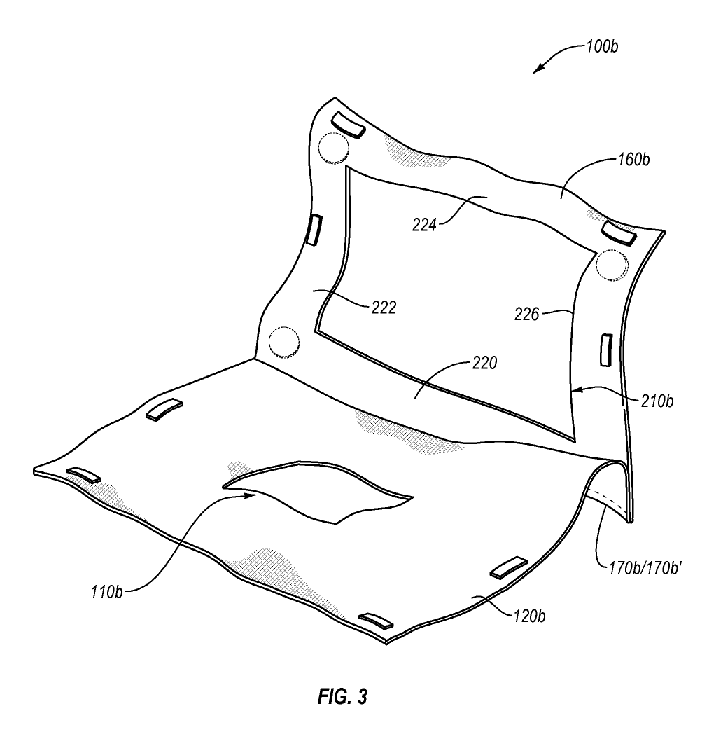

Furthermore, although in one or more implementations the dryer sheet holder may have a solid back panel, it should be noted that this invention is not so limited. In at least one implementation, as illustrated in FIG. 3, a dryer sheet holder 100b can include a front panel 120b coupled to a back panel 160b. Except as otherwise described below, the dryer sheet holder 100b can be substantially the same as dryer sheet holders 100, 100a (FIGS. 1-2B). For instance, the back panel 160b of the dryer sheet holder 100b can have an opening 210b.

Incorporating such opening 210b can allow the manufacturer to reduce the amount of material used in making the dryer sheet holder 100b. For example, the back panel 160b can comprise four interconnected segments 220, 222, 224, 226. Where the back panel 160b comprises a fabric sheet material, the manufacturer can stitch the segments 220, 222, 224, 226 together to form the back panel 160b. Alternatively, the manufacturer can cut a center piece out of the back panel 160b to from the opening 210b. As such, the manufacturer can then reuse this material in other products or other components of the dryer sheet holder.

As described above, in at least one implementation, the front panel 120b and back panel 160b can be separate sheets of material (e.g., fabric sheets, thermoplastic sheets, etc.). Particularly, the front panel 120b can couple to the back panel 160b along their respective bottom edges 170b, 170b′. For example, when fabric material is used for the front panel 120b and back panel 160b, the manufacturer can stitch the front panel 120b and back panel 160b together.

Additionally, in one or more implementations, edge of the front panel 120b and/or of the back panel 160b may remain straight or unfolded. For instance, manufacturer can use nylon fabric to form the front panel 120b and/or back panel 160b. Thus, in lieu or in addition to folding the edge, the manufacturer can heat-seal the threads in the fabric (e.g., nylon) to prevent the threads from unweaving out of the edges of the fabric.

Additionally, the front panel 120b can have a dispensing opening 110b. As described above, in one or more implementations, the dispensing opening 110b can have a substantially rectangular shape. In light of this disclosure, it should be apparent to those skilled in the art that the dispensing opening 110b can have other suitable shapes, which can allow the user to remove the dryer sheets from the dryer sheet holder 100b. For example, as illustrated in FIG. 3, the dispensing opening 110b can be substantially square.

The shape and size of the dispensing opening 110b, however, can vary from one implementation to the other and may depend on the particular size and shape of the dryer sheets stored in the dryer sheet holder 100b. Thus, the dispensing opening 110b can have a rounded shape (e.g., round, elliptical, irregular rounded), a trapezoidal shape, an irregular shape, etc. Moreover, the user or manufacturer can select the particular shape and size of the dispensing opening 110b based on the user's particular aesthetic preference.

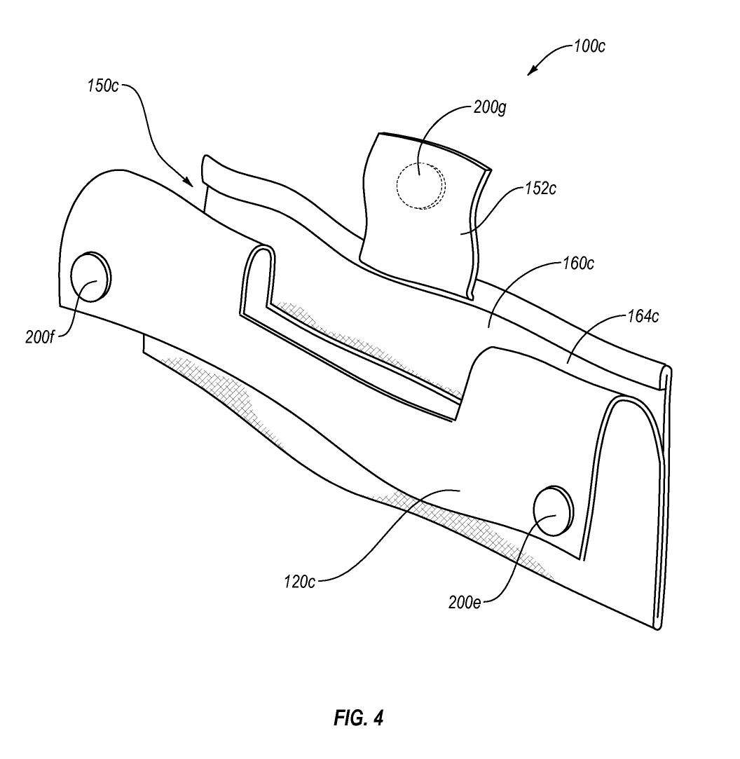

As mentioned above, in some implementations, the front and back panels can be substantially rectangular and/or can have substantially the same shape and size. This invention, however, is not so limited. Particularly, the front and/or back panels can have non-rectangular shapes. Moreover, as illustrated in FIG. 4, a dryer sheet holder 100c can include front and/or back panels that with an irregular geometric shapes. Except as otherwise described below, the dryer sheet holder 100c can be substantially the same as any one of the dryer sheet holders 100, 100a, and 100b (FIGS. 1-3).

For instance, the dryer sheet holder 100c can include a front panel 120c coupled to a back panel 160c, thereby forming a holding compartment 150c. The back panel 160c can comprise a first portion 152c and a second portion 164c coupled together to form the holding compartment 150c. It should be noted that the back panel 160c can be smaller than the front panel 120c. Accordingly, a portion of the support surface can be exposed when the dryer sheet holder 100c is at least partially opened (as illustrated in FIG. 4).

Hence, to close the dryer sheet holder 100c (e.g., after inserting the dryer sheets into the holding compartment 150c), the user can couple the front panel 120c to the support surface. For example, the front panel 120c can have coupling fasteners 200e, 200f, which can couple the front panel 120c to the support surface Likewise, as described above, the back panel 160c can have coupling fasteners, such as a coupling fastener 200g, which can couple the back panel 160c to the support surface.

As described above, the manufacturer can secure the coupling fasteners inside of the front panel 120c and/or back panel 160c (e.g., the manufacturer can secure magnets inside of the front panel 120c and/or back panel 160c). Alternatively, the manufacturer can secure the coupling fasteners, such as the coupling fasteners 200e, 200f, to an outer portion of the front panel 120c. In other words, the coupling fasteners 200e, 200f may be visible to the user when the dryer sheet holder 100c is at least partially open.

To access the holding compartment 150c (i.e., to open the dryer sheet holder 100c), the user can decouple the front panel 120c from the support surface. Similarly, to close the dryer sheet holder 100c (e.g., after inserting dryer sheets into the holding compartment 150c), the user can couple the coupling fasteners 200e, 200f and, consequently, the front panel 120c, to the support surface. It should be noted that directly coupling the front panel 120c to the support surface, in lieu of the back panel 160c, can reduce the number of fasteners required for the dryer sheet holder 100c (i.e., the fasteners and coupling fasteners), which can reduce the overall manufacturing cost of the dryer sheet holder 100c. Moreover, configuration of the back panel 160c can reduce the amount of material used for the dryer sheet holder 100c, which also can reduce the manufacturing cost of the dryer sheet holder 100c.

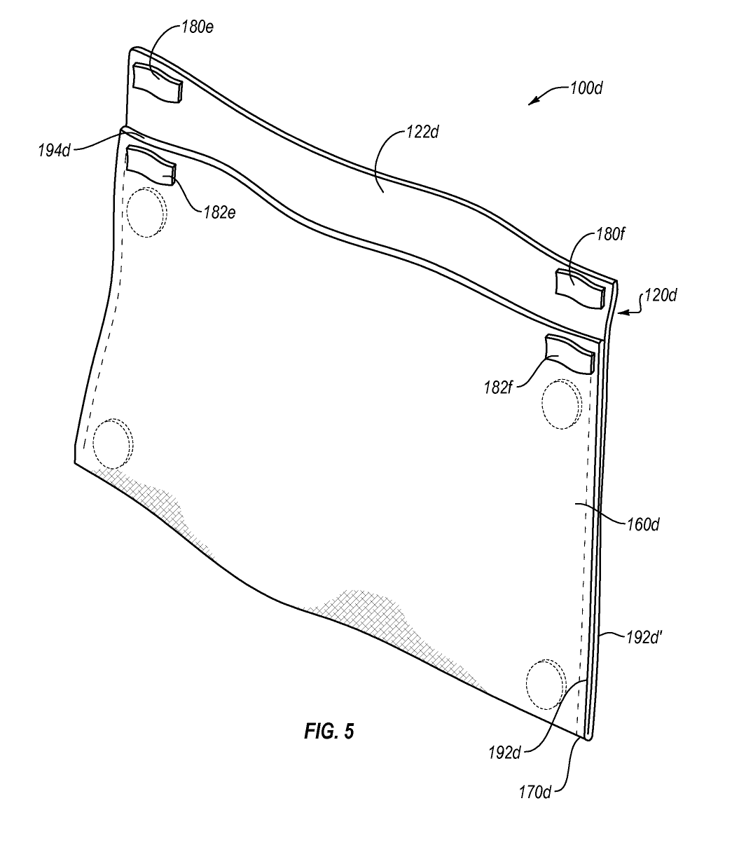

Although implementations of the dryer sheet holder described above address front and back panels that couple together through multiple fasteners located therebetween, it should be appreciated that this invention is not so limited. For example, FIG. 5 illustrates an alternative implementation of a dryer sheet holder 100d. The dryer sheet holder 100d can be substantially the same as any one of the dryer sheet holders 100, 100a, 100b, and 100c (FIGS. 1-4), except as otherwise described below.

In at least one implementation, the dryer sheet holder 100d can have a front panel 120d permanently coupled to the back panel 160d. In other words, in lieu of having fasteners that can allow the user to couple and decouple the front and back panels 120d, 160d, the manufacturer can permanently secure the front panel 120d to the back panel 160d. For example, where the front panel 120d and the back panel 160d comprise fabric sheet material, the manufacturer can stitch edges of the front and back panels 120d, 160d (e.g., the manufacturer can stitch edges 192d, 192d′).

Additionally, the front panel 120d can incorporate a flap 122d that can fold over a top edge 194d of the back panel 160d. That is, the flap 122d can couple to a back side of the back panel 160d. For example, the front panel 120d can be slightly larger than the back panel 160d (i.e., by the amount of the flap 122d extending past the back panel 160d). The flap 122d and the back panel 160d can have corresponding fasteners 180e, 180f, 182e, 182f, which can couple the flap 122d to the back panel 160d. As such, the flap 122d can couple the front panel 120d to the back panel 160d and allow the user to open and close the dryer sheet holder 100d.

Accordingly, the user can access the holding compartment of the dryer sheet holder 100d by decoupling the flap 122d from the back panel 160d and opening the dryer sheet holder 100d. Similarly, the user can close the dryer sheet holder 100d (and the holding compartment thereof) by securing the 122d to the back panel 160d. As the 122d couples to the back panel 160d, the 122d forms a fold about the top edge 194d of the back panel 160d. Hence, the flap 122 forms a closed top edge of the dryer sheet holder 100d. In other words, the front panel 120d and the back panel 160d do not form a seam therebetween at the top edge of the dryer sheet holder 100d.

Such configuration can present a more pleasing aesthetic to the user. Moreover, the closed top edge of the dryer sheet holder 100d can provide additional protection to the dryer sheets located in the holding compartment of the dryer sheet holder 100d. For instance, the flap 122d can protect the dryer sheets from accidental spillage of liquid onto the dryer sheet holder 100d. Furthermore, in light of this disclosure, those skilled in the art should appreciate that the manufacturer can construct the dryer sheet holder 100d from waterproof material (e.g., waterproof fabric, thermoplastic sheets, etc.).

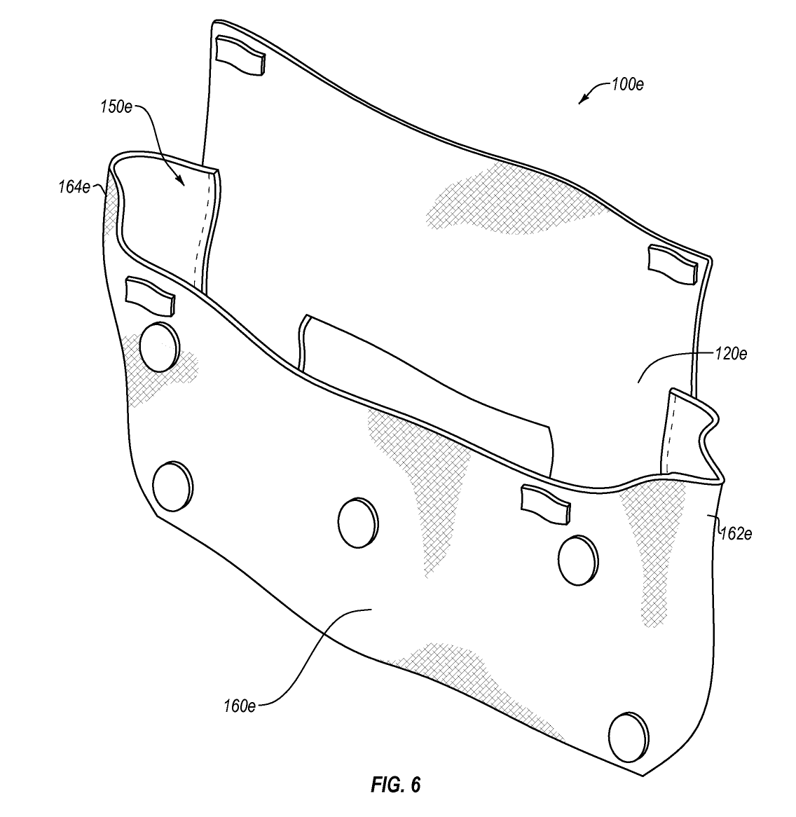

Additionally, in at least one implementation, as illustrated in FIG. 6, a dryer sheet holder 100e can have an enlarged capacity holding compartment 150e. The dryer sheet holder 100e can be substantially the same as any one of the dryer sheet holders 100, 100a, 100b, 100c, and 100e (FIGS. 1-5), except as otherwise described below. For example, the dryer sheet holder 100e can have a front panel 120e coupled to a back panel 160e. Moreover, the back panel 160e can be larger than the front panel 120e (i.e., the back panel can have portions of extra material). More specifically, the back panel 160e can have expander portions 162e, 164e, which can couple to the front panel 120e, thereby coupling the back panel 160e to the front panel 120e.

Additionally or alternatively, the front panel 120 can be larger than the back panel 160e. Furthermore, both the front and the back panels 120e, 160e can provide the additional material that can form the expander portions 162e, 164e. Hence, it should be noted that the expander portions 162e, 164e may be formed from material comprising the front and/or the back panels 120e, 160e. Also, the expander portions 162e, 164e may comprise material separate from the front and back panels 120e, 160e.

The expander portions 162e, 164e can allow the back panel 160e and the front panel 120e to move farther away from each other. For instance, to facilitate expansion, the expander portions 162e, 164e can comprise elastic material. Consequently, the holding compartment 150e can have a greater capacity (than, for example dryer sheet holder 100a (FIG. 2A)) and can accommodate a great amount of dryer sheets therein. At the same time, while the dryer sheet holder 100e can have a greater capacity, the expander portions 162e, 164e can collapse as the quantity of dryer sheets in the holding compartment 150e declines (i.e., as the user removes dryer sheets from the dryer sheet holder 100e). Thus, while the dryer sheet holder 100e can accommodate a greater number of dryer sheets (than, for instance, dryer sheet holder 100a (FIG. 2A)), the dryer sheet holder 100e also can collapse to accommodate fewer dryer sheets, thereby can occupying less space.

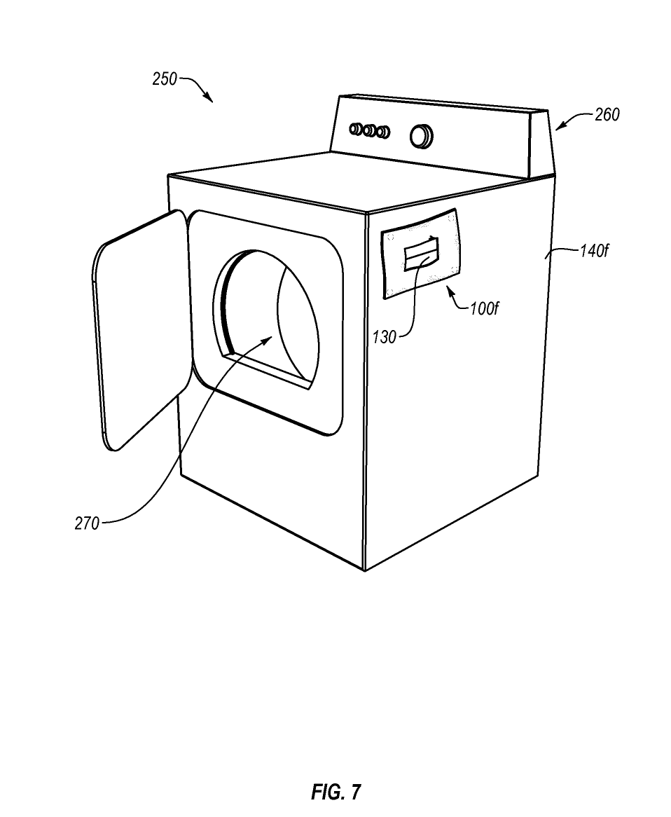

As described above, the user can incorporate the dryer sheet holder into a clothes drying system. For example, FIG. 7 illustrates one implementation of a clothes drying system 250. Particularly, the clothes drying system 250 includes a dryer sheet holder 100f, which can be the same as any one of the dryer sheet holder 100, dryer sheet holders 100a, 100b, 100c, 100d, and 100e (FIGS. 1-6), and a drying machine 260. The drying machine 260 can have a drying compartment 270 configured to accept a load of laundry for drying.

The user can secure the dryer sheet holder 100f to a support surface 140f, which may be on the drying machine 260. Particularly, the user can secure the dryer sheet holder 100f at a convenient location on the support surface 140f. Moreover, as described above, the support surface 140f may be located on a cabinet, a wall, or any other object, as may be convenient or suitable for the user.

The dryer sheet holder 100f can include one or more dryer sheets 130 therein. Hence, the user can remove the dryer sheets 130 from the dryer sheet holder 100f and insert the dryer sheets 130 into the drying compartment 270, together with the load of laundry. Convenient location of the dryer sheet holder 100f can reduce the number of instance when the user may forget to place the one or more dryer sheets 130 into the drying compartment 270. Consequently, the user can obtain more consistent results during the laundry drying process. Furthermore, a dryer sheet manufacturer can increase consumption of dryer sheets by reducing the unintentional omissions of dryer sheets from laundry loads.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A flexible dryer sheet holder for holding dryer sheets at a convenient location relative to a drying machine, the flexible dryer sheet holder comprising:
a front panel having a left edge, a right edge, a top edge, and a bottom edge, wherein the front panel has a dispensing opening therethrough;
a back panel having a left edge, a right edge, a top edge, and a bottom edge, wherein:
the left edge of the front panel is coupled to the left edge of the back panel,
the right edge of the front panel is coupled to the right edge of the back panel,
the bottom edge of the front panel is coupled to the bottom edge of the back panel,
when coupled, the bottom edges of the front and back panels being configured to form a holding compartment for storing a plurality of dryer sheets, and
the dispensing opening in the front panel being configured to allow access to a front dryer sheet of the plurality of dryer sheets; and
one or more coupling fasteners secured to the back panel, the one or more fasteners being configured to couple the back panel to a support surface.

2. The flexible dryer sheet holder as recited in claim 1, wherein the front panel and the back panel comprise a fabric sheet material.

3. The flexible dryer sheet holder as recited in claim 1, wherein the front panel and the back panel comprise a single sheet of material.

4. The flexible dryer sheet holder as recited in claim 1, wherein one or more of the front panel and the back panel further comprise at least one fastener configured to couple the front panel to the back panel.

5. The flexible dryer sheet holder as recited in claim 4, wherein the at least one fastener is configured to removably couple one or more of the left edge of the front panel to the left edge of the back panel and the right edge of the front panel to the right edge of the back panel.

6. The flexible dryer sheet holder as recited in claim 1, wherein the front panel further comprises a flap configured to close the holding compartment.

7. The flexible dryer sheet holder as recited in claim 6, wherein the flap couples to a back side of the back panel.

8. The flexible dryer sheet holder as recited in claim 1, further comprising expander portions coupling the left edge of the front panel to the left edge of the back panel and the right edge of the front panel to the right edge of the back panel.

9. The flexible dryer sheet holder as recited in claim 8, wherein one or more of the expander portions comprise an elastic material.

10. A clothes drying system for drying a load of laundry and consistently incorporating one or more dryer sheets into the load of laundry during the drying thereof in a drying machine, the system comprising:
a flexible dryer sheet holder coupled to a support surface on or near the drying machine, the flexible dryer sheet holder at least partially conforming to the contour of the support surface, the flexible dryer sheet holder comprising:
a dryer sheet holding compartment formed between a front panel and a back panel,
one or more dryer sheets located in the dryer sheet compartment, and
a dispensing opening in the front panel, wherein the dispensing opening in the front panel is configured to allow access to at least one dryer sheet of the one or more dryer sheets located in the dryer sheet holding compartment.

11. The system as recited in claim 10, wherein the flexible dryer sheet holder is removably coupled to the drying machine.

12. The system as recited in claim 11, wherein the back panel of the flexible dryer sheet holder further comprises a plurality of magnetic coupling fasteners configured to couple the flexible dryer sheet holder to the drying machine.

13. The system as recited in claim 10, wherein the front panel is removably coupled to the back panel.

14. The system as recited in claim 13, wherein one or more of the front panel and the back panel further comprise a plurality of fasteners configured to removably couple the front panel to the back panel.

15. The system as recited in claim 10, wherein the front panel is permanently coupled to the back panel.

16. The system as recited in claim 10, wherein the front panel is removably coupled to the support surface.

17. The system as recited in claim 14, wherein fasteners comprise hook and loop fasteners.

18. A method of providing dryer sheets to a user who is placing a load of laundry into a drying machine, before commencement of a drying process, in a manner that facilitates more frequent use of the dryer sheets during the drying process and aids unintentional omissions of the dryer sheets from the drying process by the user, the method comprising:
coupling a flexible dryer sheet holder to a support surface on or near a drying machine in a manner that a back panel of the dryer sheet holder at least partially conforms with the support surface;
opening a dryer sheet holding compartment of the dryer sheet holder by at least partially decoupling a front panel from the back panel of the dryer sheet holder;
inserting a plurality of dryer sheets into the dryer sheet compartment of the dryer sheet holder;
closing the dryer sheet holding compartment; and
allowing the user to access the dryer sheets located in the dryer sheet holding compartment by having at least a portion of a front dryer sheet of the plurality of dryer sheets accessible through a dispensing opening in the front panel of the dryer sheet holder.

19. The method as recited in claim 18, wherein closing the dryer sheet holding compartment comprises coupling the front panel to the back panel.

20. The method as recited in claim 18, wherein closing the dryer sheet holding compartment comprises coupling the front panel of the dryer sheet holder to the support surface.
